(19) United States
(12) Patent Application Publication
(10) Pub. No.: US 2012/0298763 A1
(43) Pub. Date: Nov. 29, 2012

(54) DISTRIBUTED NETWORKED THERMOSTAT SYSTEM AND METHOD

(75) Inventor: Joel K. Young, Eden Prairie, MN (US)

(73) Assignee: Digi International Inc., Minnetonka, MN (US)

(21) Appl. No.: 13/116,800

(22) Filed: May 26, 2011

(51) Int. Cl. G05D 23/19; F24F 11/00

(52) U.S. Cl. 236/51

(57) ABSTRACT

Various embodiments include methods and systems for a distributed networked device controller such as a thermostat.

### BACKGROUND

Thermostats are ubiquitous in home HVAC (Heating, Ventilation and Air Conditioning) systems. They range from simple mechanical switches, to highly programmable zoned heating controllers. In a drive to increase efficiency in home heating and cooling, consumers have turned to highly programmable and intelligent thermostats. Such thermostats are notoriously difficult to program and configure. Most such intelligent thermostats are stand-alone modules, although there have been attempts to network intelligent thermostats. The common approach is to add a separate network communications interface to the intelligent thermostat, preserving the complex, and difficult to use, user interface. Such an approach adds cost and further complexity to an already complex system.

Networked systems have been proposed. They try to make the configuration and programming easier through the use of somewhat easier to use web page based configuration interfaces. In one such approach, the consumer connects to an Internet thermostat through an IP connection in order to send instructions to the Internet thermostat to change its programming. Radio Thermostat of America, for example, offers web and mobile applications that work with their networked thermostat to allow the consumer to control the thermostat over the Internet.

### BRIEF DESCRIPTION OF THE DRAWINGS

In the drawings, which are not necessarily drawn to scale, like numerals may describe similar components in different views. Like numerals having different letter suffixes represent different instances of similar components. The drawings illustrate generally, by way of example, but not by way of limitation, various embodiments discussed in the present document.

FIG. 1 illustrates an example system for a distributed networked thermostat, according to one embodiment.

FIGS. 2A-2B illustrate other example systems for a distributed networked thermostat.

FIG. 3 illustrates a flowchart for an example method for a controlling a distributed networked thermostat, according to one embodiment.

FIG. 4 illustrates an example system for a cloud-based distributed networked thermostat system, according to one embodiment.

FIG. 5 illustrates an example thermostat module, according to one embodiment.

FIG. 6 illustrates operation of the example thermostat module of FIG. 5, according to one embodiment.

FIGS. 7 and 8 illustrate other example systems for a distributed networked thermostat system.

FIGS. 9 and 10 illustrate example systems for a distributed networked device control system.

FIG. 11 illustrates a block diagram of an example machine upon which any one or more of the systems can use or methods can be run.

### DETAILED DESCRIPTION

As noted above, networked systems have been proposed. They try to make the configuration and programming easier through the use of somewhat easier to use web page based configuration interfaces. In one such approach, the consumer connects to an Internet thermostat through an IP connection in order to send instructions to the Internet thermostat to change its programming.

Such systems, while addressing the need to communicate with instruments such as thermostats over a communication network such as the Internet, still suffer from too much complexity. The program and profile is often duplicated in multiple locations, changes to the program must still be downloaded into the Thermostat and there remains a control conflict in that someone may locally modify the thermostat configuration, only to have it overwritten by a centralized system.

A better approach is to remove most of the intelligence from the networked thermostat, leaving primarily the communications capability, the control capability and, where appropriate, the measurement capability. The programmable nature of the thermostat is, instead, performed at a remote location.

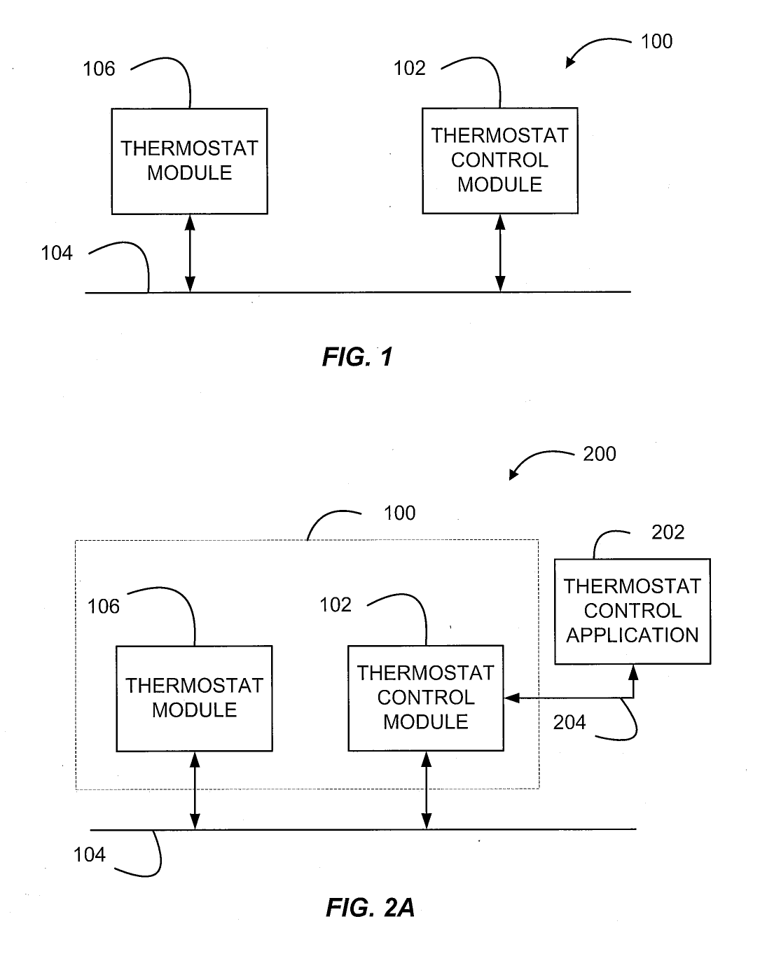

FIG. 1 illustrates an example distributed networked thermostat 100, according to one embodiment. Thermostat 100 includes a thermostat control module 102 connected across a first communication network 104 to a thermostat module 106.

Thermostat module 106 includes a sensor 108 for measuring room temperature, a register 110 for storing a current temperature and controls 112 for controlling an HVAC system. In one such embodiment, controls 112 are controls such as are used in conventional HVAC thermostats.

Thermostat control module 102 includes a first network interface capable of being connected to the first communication network, a second network interface capable of being connected to a second communication network, and a programmable controller that stored schedule logic used to control thermostat module 106.

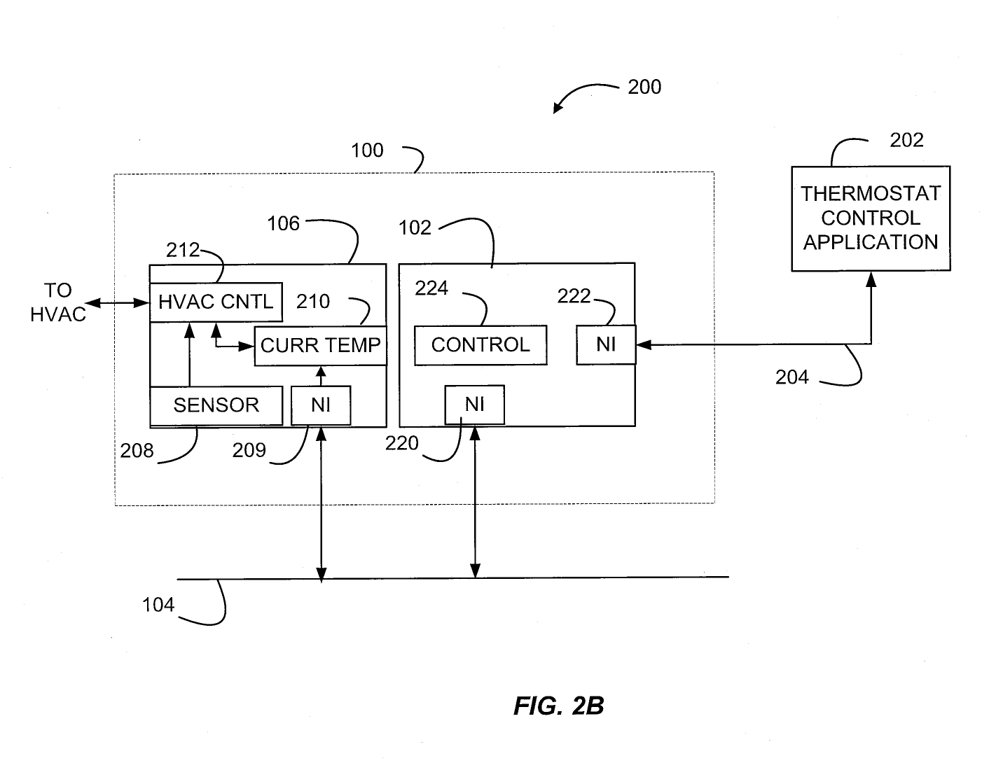

In one embodiment, thermostat control module 102 is connected across a second communication network to server running a thermostat control application. On such embodiment is shown in FIG. 2A.

In the embodiment shown in FIG. 2A, distributed networked thermostat system 200 includes distributed networked thermostat 100 connected through a second communication network 204 to server 202. In one such embodiment, thermostat control application operates as a cloud-based application.

One embodiment of distributed networked thermostat system 200 is shown in FIG. 2B. In the embodiment shown, thermostat module 106 includes a sensor 208 for measuring room temperature, a network interface 209, a register 210 for storing a current temperature and controls 212 for controlling an HVAC system. In one such embodiment, controls 212 are controls such as are used in conventional HVAC thermostats.

Thermostat control module 102 includes a first network interface 220 capable of being connected to the first communication network 104, a second network interface 222 capable of being connected to a second communication network, and a programmable controller 224 that stores schedule logic used to control thermostat module 106. In one embodiment, thermostat control module 102 serves as a gateway for access, via network 104, to other devices at the location.

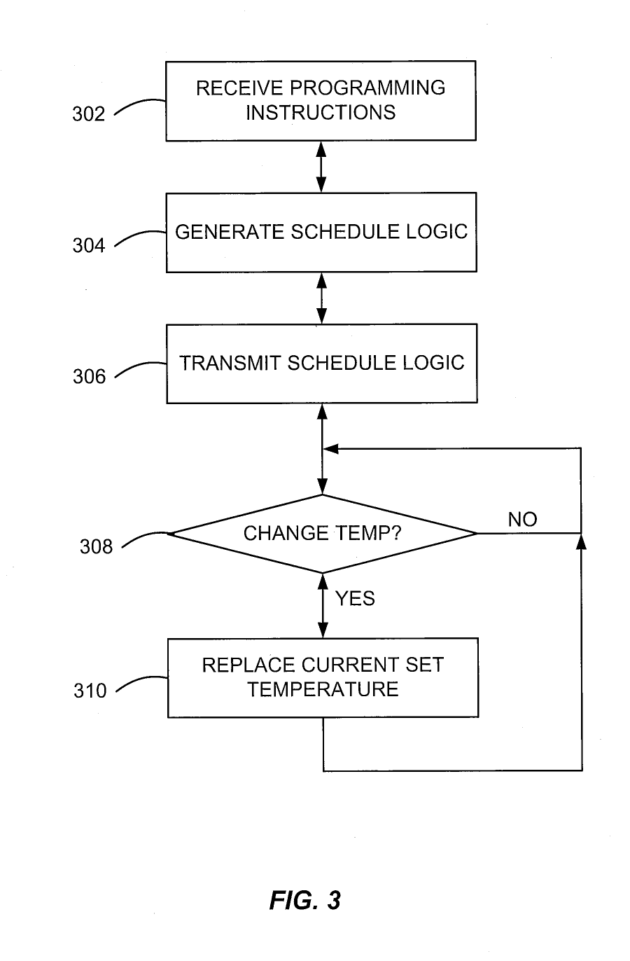

In one embodiment, server 202 is located at a location remote from thermostat 100. As shown in FIG. 3, in one embodiment, at 302, server 202 receives programming instructions for the thermostat and executes, at 304, programming instructions from within thermostat control application to create schedule logic. At 306, the schedule logic is transmitted from server 202 across communication network 204 to thermostat controller module 106.

At 308, thermostat control module 102 determines, from the downloaded schedule logic, whether it is time to change the current set temperature in thermostat module 106. If not, control moves to 308.

If, at 308, thermostat control module 102 determines it is time to change the current set temperature in thermostat module 106, control moves to 310 and a new temperature value is transmitted from thermostat controller module 102 to thermostat module 106. When the new temperature value is received by thermostat module 106, the current set temperature is replaced in the thermostat module with the new temperature value. The thermostat module then senses a sensed temperature and modifies operation of the HVAC system as a function of the sensed temperature and the new current set temperature.

Systems 100 and 200, as described above, change the traditional paradigm of the intelligent programmable thermostat by changing the thermostat itself into a simple electronic thermostat with networked communication abilities—keeping the intelligence and program logic residing within the broader network. This makes the thermostat itself intelligent in communication, but simple in temperature sensing and HVAC switching. The benefit is that the thermostat is very low cost, and simple to use.

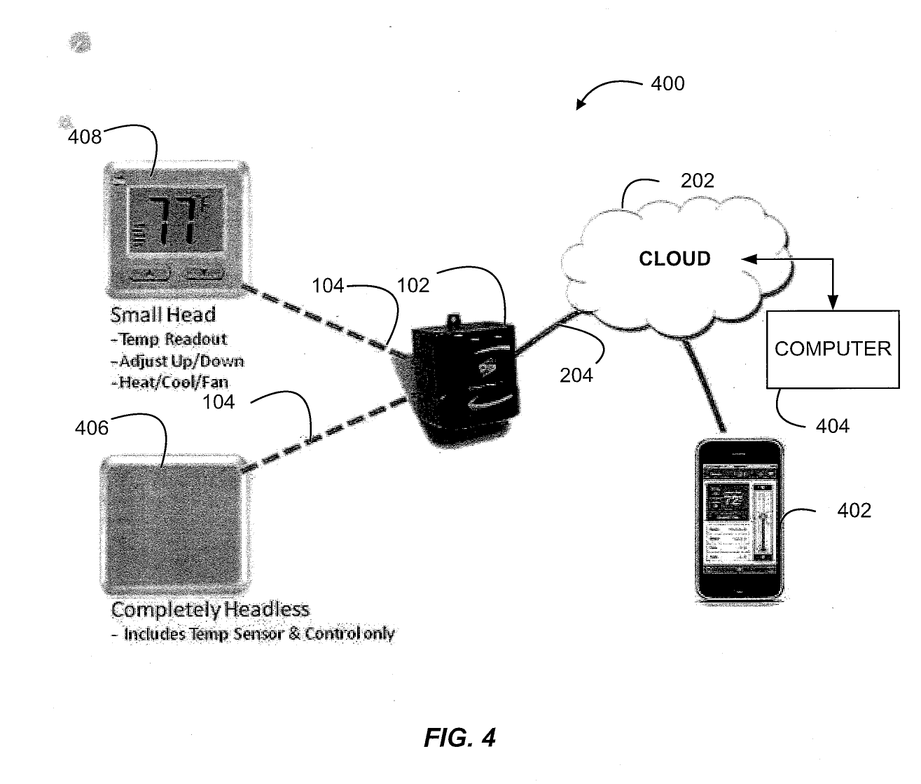

In one embodiment, system control is made easily accessible to the user through the use of a user interface device such as a computer, a smart phone or other web interface. One such embodiment is shown in FIG. 4. In the embodiment shown in FIG. 4, distributed networked thermostat system 400 includes a distributed networked thermostat 100 connected through a second communication network 204 to a cloud-based thermostat control application 202. In the embodiment shown, cloud-based thermostat control application 202 can be configured via a thermostat user interface application on, e.g., a smart phone 402. An advantage of a portable device such as a smart phone or tablet is that the thermostat user interface application is placed “on the hip” via those devices.

In another embodiment, control of system 400 is through a thermostat user interface application running on computer 404.

In one embodiment, thermostat control application 202 includes an application that communicates over the Internet with a user interface device running a thermostat user interface application. In one such embodiment, the user interface application is a programmable thermostat interface, and thermostat control application 202 receives programming instructions for the thermostat when changes are made on the programmable thermostat interface on the user interface device.

Two types of thermostat modules are shown in FIG. 4. Thermostat module 406 is a thermostat module 106 that is completely headless. That is, it has no display or local control. Thermostat module 406 receives a new temperature value from thermostat control module 102 and replaces the current set temperature with the new temperature value. Thermostat module 406 then senses a sensed temperature and modifies operation of the HVAC system as a function of the sensed temperature and the new current set temperature.

The second type of thermostat module 106 is shown as thermostat module 408 in FIG. 4. Thermostat module 408 includes simplified local control and a display for displaying the current set temperature. In the embodiment shown, the user uses the up/down buttons to override the schedule logic, or to turn on or off the heat, air conditioning or HVAC system fan. Thermostat module 408 also receives a new temperature value from thermostat control module 106 and replaces the current set temperature with the new temperature value. Both thermostat module 406 and thermostat module 408 remember the set point and implements the basic thermostat control function. They then sense a sensed temperature and modify operation of the HVAC system as a function of the sensed temperature and the new current set temperature.

In one embodiment, thermostat module 408 displays the current set temperature with an indication as to whether the temperature displayed is the temperature dictated by the schedule logic, or is the result of an override by the user. The next transmitted temperature from thermostat control module 106 places thermostat module 408 back into normal operation with the current set temperature as dictated by thermostat control module 102.

In the embodiment shown in FIG. 4, thermostat control module 102 is a gateway that communicates with server 202 over a wide area network (WAN) such as the Internet. In the embodiment shown in FIG. 4, gateway 102 communicates with an application running in the cloud 202. As used herein, cloud architecture (e.g. a cloud) is a logical computing system including one or more virtualization layers between cloud-based applications and hardware components providing processing, memory (i.e., system memory that maintains the state of a currently running computer system), and storage, such as computer servers, storage devices, and network components among other hardware elements. In some examples, the cloud includes a plurality of computer servers to provide processor, memory, and storage resources to a cloud infrastructure virtualization layer. In some examples, the cloud includes one or more cloud platform layers that provide a variety of application programming interfaces (APIs) for cloud-based applications to use the cloud infrastructure.

In one such embodiment, gateway 102 is a virtual gateway such as that described in “CLOUD ENABLED VIRTUAL GATEWAY”, application Ser. No. ______, filed herewith, the description of which is incorporated herein by reference.

Communication network 204 may be any applicable communication network. Examples of communication networks used for utilities are given by Khalifa et al. in “A Survey of Communication Protocols for Automatic Meter Reading Applications,” published by IEEE Communications Surveys & Tutorials on May 27, 2010 and updated on May 5, 2011, the descriptions of which are incorporated herein by reference. Other known communications networks, such as those provided over the cable or phone lines, could be used as well.

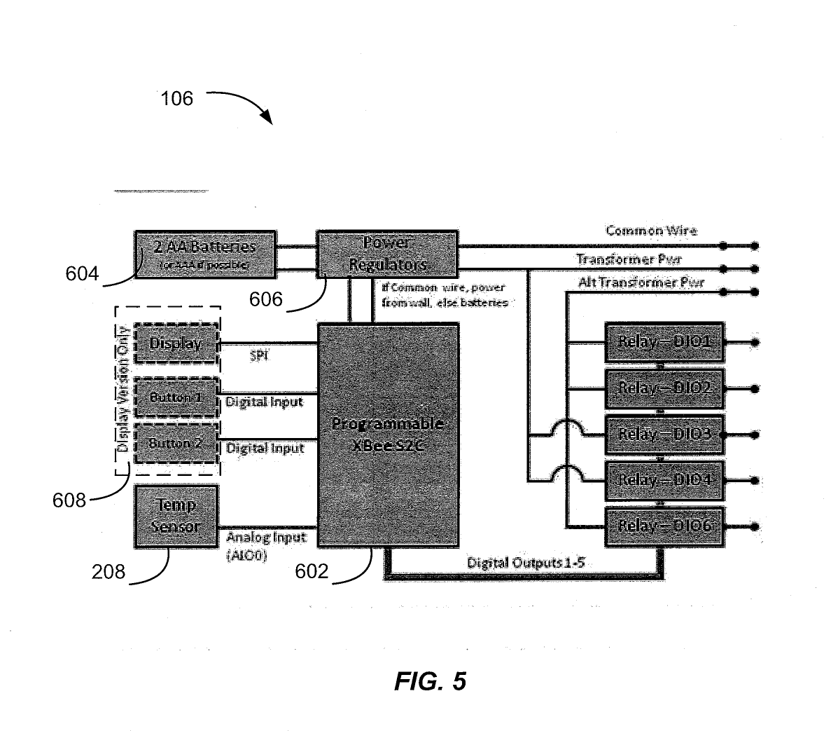

One embodiment of thermostat module 106 is shown in FIG. 5. In the embodiment shown in FIG. 5, thermostat module 106 includes a sensor 208 for measuring room temperature, a control circuit 602 which provides both a register 210 for storing a current temperature and communication capability over a wireless mesh network, and controls 212 for controlling an HVAC system. In the embodiment shown, controls 212 include relays DIO1-DIO4 and DIO6 connected via Digital Outputs 1-5 to control circuit 602. Relays DIO1-DIO4 and DIO6 are configured to provide HVAC control signals similar to those used in conventional HVAC thermostats.

In one embodiment, module 106 is powered via power from the HVAC system. In another embodiment, power is supplied via batteries 604. In the embodiment shown, power regulators 606 regulate the power received from the batteries 604 or from an external source before providing it to control circuit 602.

As noted above, thermostat modules 106 may be headless (like module 406) or may include some limited user interface (like module 408). In one embodiment, such as is shown in FIG. 5, the limited user interface is supplied via interface 608 as shown. In one embodiment, each module 106 includes a pin-hole button that can be used to establish communication with a wireless form of communication network 104 (e.g., a mesh network). In one such embodiment, a serial port is accessible for wired programming and configuration of module 106, if necessary.

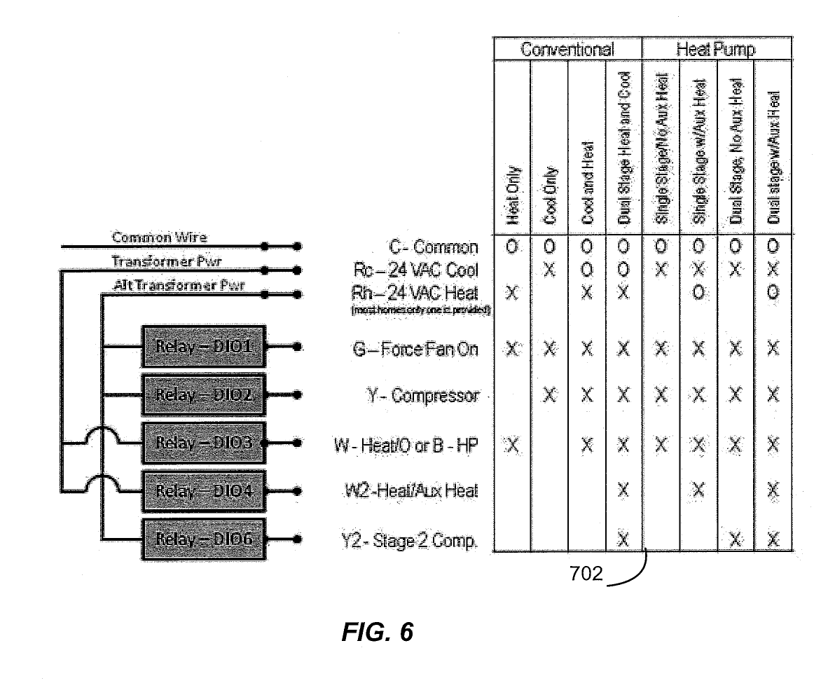

As noted above, relays DIO1-DIO4 and DIO6 control the HVAC system. One embodiment of such control is shown in FIG. 6. In table 702 of FIG. 6, DIO1 is G, DIO2 is Y, DIO3 is W, DIO4 is W2 and DIO6 is Y2. In one embodiment, relays DIO1-4 and DIO6 are set or reset via digital outputs of control circuit 602, as shown in FIG. 5. Operation is as shown in table 702.

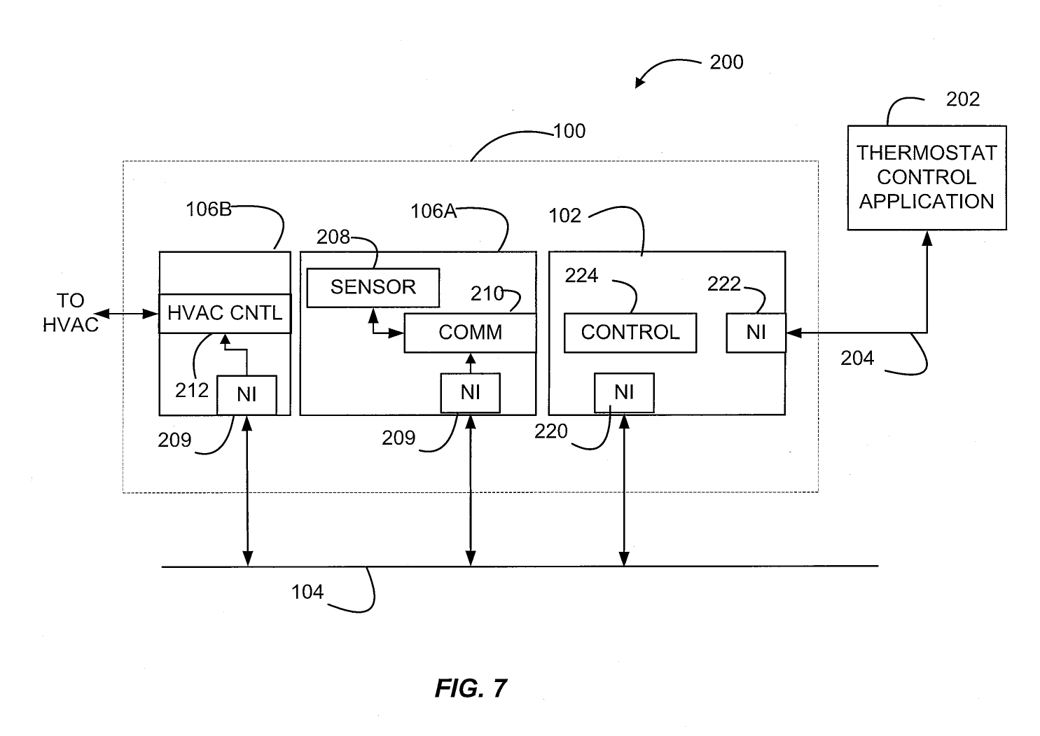

In one embodiment the HVAC control and communication functions of thermostat module 106 are separated into thermostat sensor module 106A and thermostat HVAC control module 106B as shown in FIG. 7. One advantage of such an embodiment is that the HVAC controls can be placed in close proximity to the HVAC unit while the sensor module 106A can be placed in the room where the temperature is being controlled. In one embodiment, HVAC Control 212 includes relays similar to relays DIO1-DIO4 and DIO6 as shown in FIG. 5 and a network interface that receives instructions from module 106A via network 104 for control of the relays. The instructions received are a function of the temperature set in register 210.

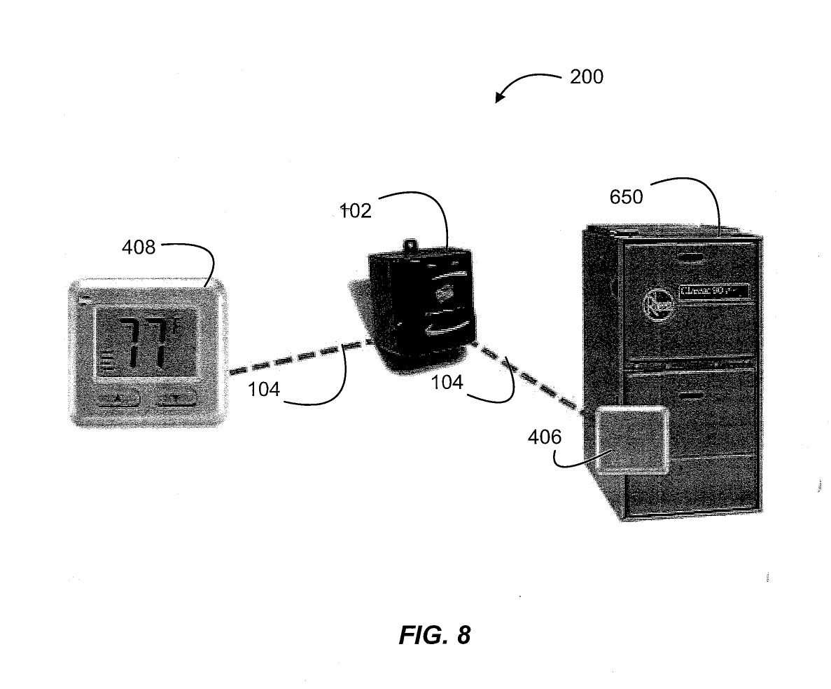

In one embodiment, modules 406 and 408 of FIG. 4 are used in conjunction to control an HVAC system 650. Once such embodiment is shown in FIG. 8. In one such embodiment, modules 406 and 408 communicate via network 104. When module 408 senses a temperature other than the set temperature, it informs module 406, which adjusts HVAC system 650 accordingly.

In another embodiment, modules 406 and 408 provide zone control of different heating and cooling zones, while under control of module 102.

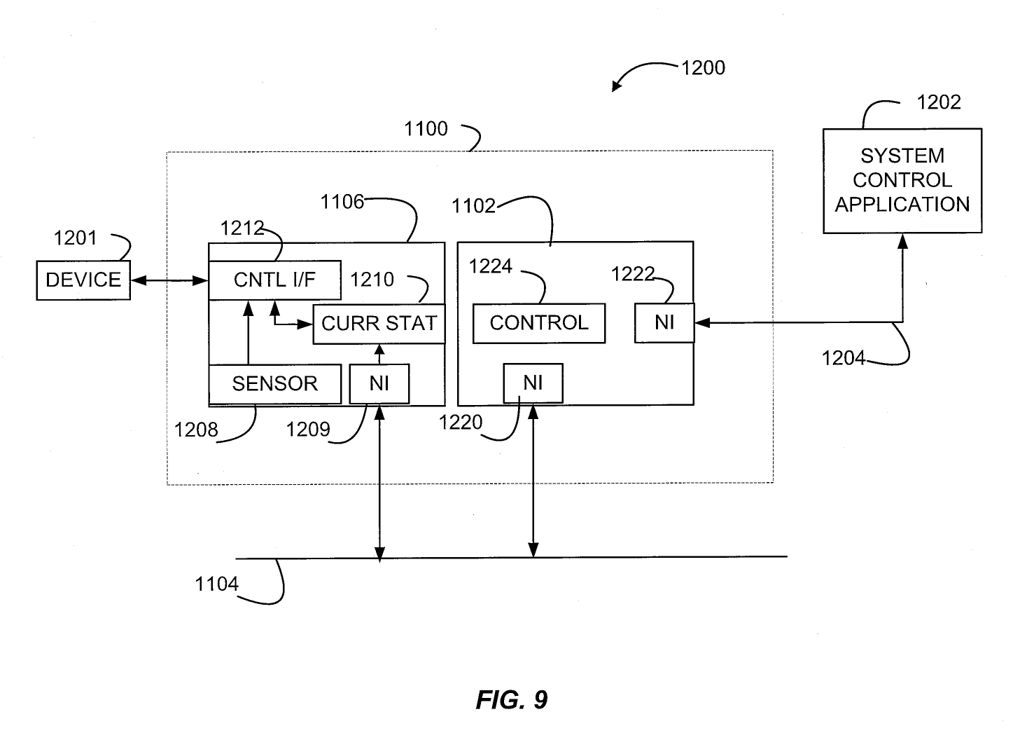

A distributed networked system can be used to control other devices as well. An example system 1200 for controlling a device 1201 is shown in FIG. 9. In the embodiment shown, system 1200 includes a system control application executing on a server 1202, a system control module 1102 and a device control module 1106. Device control module 1106 includes a sensor 1208 for measuring a parameter of interest for device 1201. Device control module 1106 also includes a network interface 1209, a register 1210 for storing a current parameter value and controls 1212 for controlling device 1201.

System control module 1102 includes a first network interface 1220 capable of being connected to the first communication network 1104, a second network interface 1222 capable of being connected to a second communication network, and a programmable controller 1224 that stores schedule logic used to control device control module 1106. In one embodiment, system control module 1102 serves as a gateway for access, via network 1104, to other devices at the location. Operation is similar to that described for system 100, 200 and 400 above.

In one embodiment, system control is made easily accessible to the user through the use of a user interface device such as a computer, a smart phone or other web interface. As in the system shown in FIG. 4, a cloud-based device control application 202 can be configured via a device user interface application on, e.g., a smart phone 402 or a computer 404.

In one such embodiment, device control application 202 includes an application that communicates over the Internet with a user interface device running a device user interface application. In one such embodiment, the user interface application presents a device interface, and device control application 202 receives programming instructions for the device to be controlled when changes are made on the device interface via the user interface device.

In one embodiment, system 1200 is used to control operation of lawn sprinklers in a sprinkler system. In one such embodiment, sensor 1208 is a rain sensor and the device user interface application presents an interface similar to those used to control programmable sprinkler systems.

In another embodiment, system 1200 is used as a radiant heat controller.

System 1200 can be also be used to control devices such as refrigerators, ceiling fans, pool pumps and lamps via a remote server or cloud-based application.

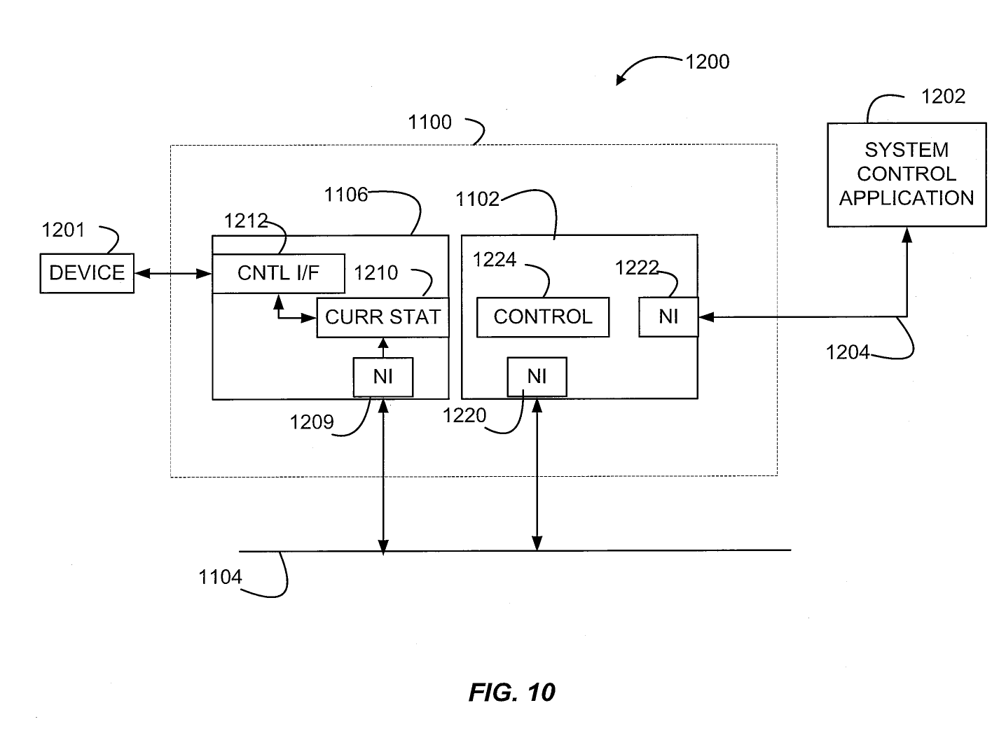

Another distributed networked system is shown in FIG. 10. In the example shown in FIG. 10, system 1200 controls a device 1201. In the embodiment shown, system 1200 includes a system control application executing on a server 1202, a system control module 1102 and a device control module 1106. Device control module 1106 includes a network interface 1209, a register 1210 for storing a current parameter value and controls 1212 for controlling device 1201. In this embodiment, there is no sensor.

System control module 1102 includes a first network interface 1220 capable of being connected to the first communication network 1104, a second network interface 1222 capable of being connected to a second communication network, and a programmable controller 1224 that stores schedule logic used to control device control module 1106. In one embodiment, system control module 1102 serves as a gateway for access, via network 1104, to other devices at the location. Operation is similar to that described for system 100, 200 and 400 above.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client or server computer system) or one or more processors can be configured by software (e.g., an application or application portion) as a hardware-implemented module that operates to perform certain operations as described herein.

In various examples, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor can be configured as respective different hardware-implemented modules at different times. Software can accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple of such hardware-implemented modules exist contemporaneously, communications can be achieved through signal transmission (e.g., over appropriate circuits and buses) that connect the hardware-implemented modules. In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation and store the output of that operation in a memory device to which it is communicatively coupled. A further hardware-implemented module can then, at a later time, access the memory device to retrieve and process the stored output. Hardware-implemented modules can also initiate communications with input or output devices and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or as a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., Application Program Interfaces (APIs).)

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

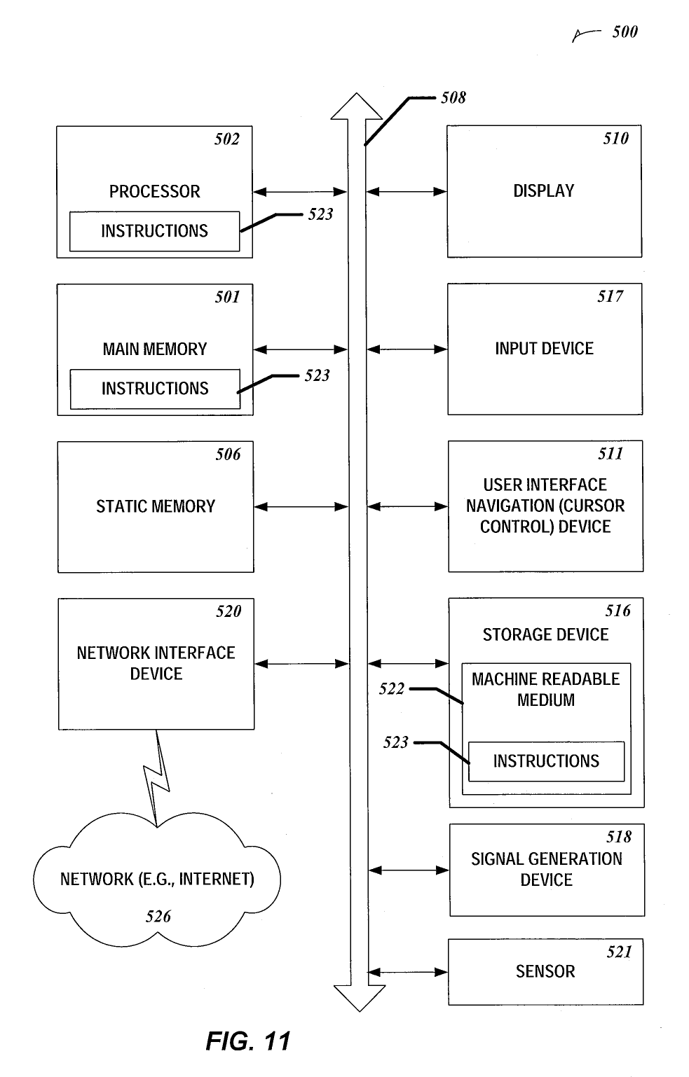

FIG. 11 is a block diagram illustrating an example machine upon which any one or more of the methodologies herein discussed can be run. In alternative embodiments, the machine operates as a standalone device or can be connected (e.g., networked) to other machines. In a networked deployment, the machine can operate in the capacity of either a server or a client machine in server-client network environments, or it can act as a peer machine in peer-to-peer (or distributed) network environments. The machine can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes a processor 502 (e.g., a central processing unit (CPU), a graphics processing unit (GPU) or both), a main memory 501 and a static memory 506, which communicate with each other via a bus 508. The computer system 500 can further include a display unit 510, an alphanumeric input device 517 (e.g., a keyboard), and a user interface (UI) navigation device 511 (e.g., a mouse). In one embodiment, the display unit 510, input device 517 and UI navigation device 511 are a touch screen display. The computer system 500 can additionally include a storage device (e.g., drive unit) 516, a signal generation device 518 (e.g., a speaker or a light emitting diode (LED)), a network interface device 520, and one or more sensors 521, such as a global positioning system (GPS) sensor, compass, accelerometer, or other sensor.

The storage device 516 includes a machine-readable medium 522 on which is stored one or more sets of data structures and instructions 523 (e.g., software) embodying or utilized by any one or more of the methodologies or functions described herein. The instructions 523 can also reside, completely or at least partially, within the main memory 501 and/or within the processor 502 during execution thereof by the computer system 500, with the main memory 501 and the processor 502 also constituting machine-readable media.

While the machine-readable medium 522 is illustrated in an example embodiment to be a single medium, the term “machine-readable medium” can include a single medium or multiple media (e.g., a centralized or distributed database, and/or associated caches and servers) that store the one or more instructions 523. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 523 can further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a tangible computer-readable medium or tangible machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. In a heating, ventilation and air conditioning (HVAC) system, a method for controlling a thermostat, wherein the thermostat includes a thermostat control module connected across a first network to a thermostat module, the method comprising:
receiving, at a server located at a location remote from the thermostat, programming instructions for the thermostat;
executing the programming instructions from within an application executing on the server in order to create schedule logic;
transmitting the schedule logic from the server across a communication network to a thermostat controller module;
transmitting a new temperature value from the thermostat controller module to the thermostat module when indicated by the schedule logic;
receiving the new temperature value at the thermostat module;
replacing a current set temperature in the thermostat module with the new temperature value;
sensing, at the thermostat module, a sensed temperature; and
modifying operation of the HVAC system as a function of the sensed temperature and the new current set temperature.

2. The method of claim 1, wherein receiving programming instructions for a thermostat includes executing an application on a smart phone that communicates over a communication network with the server, wherein the application provides a user interface for entering programming instructions for the thermostat.

3. The method of claim 1, wherein receiving programming instructions for a thermostat includes executing an application on a computer that communicates over a communication network with the server, wherein the application provides a user interface for entering programming instructions for the thermostat.

4. The method of claim 1, wherein the thermostat module includes one or more temperature control buttons, wherein activation of one of the one or more temperature control buttons overrides the current set temperature.

5. The method of claim 1, wherein the thermostat module includes a display and one or more temperature control buttons, wherein activation of one of the one or more temperature control buttons overrides the current set temperature and displays the new current set temperature on the display.

6. The method of claim 1, wherein the thermostat module includes a display and wherein sensing, at the thermostat module, a sensed temperature includes displaying the sensed temperature on the display.

7. The method of claim 1, wherein modifying operation of the HVAC system as a function of the sensed temperature and the new current set temperature includes setting relays used to control the HVAC system.

8. The method of claim 1, wherein modifying operation of the HVAC system as a function of the sensed temperature and the new current set temperature includes communicating data across the first network to a relay module, wherein the relay module modifies operation of the HVAC system.

9. The method of claim 1, wherein the server includes an application that communicates over the Internet with a user interface device running a thermostat user interface application and wherein receiving programming instructions for the thermostat includes receiving a communication from the user interface device with specific programming instructions.

10. The method of claim 9, wherein the user interface application is a programmable thermostat interface, and wherein the server receives programming instructions for the thermostat when changes are made on the programmable thermostat interface.

11. A thermostat system, comprising:
a thermostat module, wherein the thermostat module includes:
a network interface;
a temperature sensor;
a control interface for controlling an HVAC system; and
a programmable controller connected to the network interface, the temperature sensor and the control interface, wherein the programmable controller includes a current set temperature value; and
a thermostat control module, wherein the thermostat control module includes:
a first and a second network interface; and
a programmable controller connected to the network interface,
wherein the programmable controller includes program code;
wherein the thermostat control module and the thermostat module can be connected via their network interfaces;
wherein the thermostat module reads temperature from the temperature sensor and modifies operation of the HVAC system as a function of the temperature measured by the temperature sensor and the current set temperature value; and
wherein the programmable controller for thermostat control module includes program code which, when executed, causes the programmable controller for the thermostat control module to transmit a new temperature value at preselected times to the programmable controller of the thermostat module, wherein the new temperature value replaces the current set temperature value.

12. The system of claim 11, wherein the thermostat module includes one or more input controls, wherein the input controls, when activated by a user, change the current set temperature value.

13. The system of claim 11, wherein the thermostat module includes a display for displaying the current set temperature value.

14. In a system having a device to be controlled, a method for controlling the device, the method comprising:
receiving, at a server located at a location remote from the device, programming instructions for the changing operation of the device;
executing the programming instructions from within an application executing on the server in order to create schedule logic;
transmitting the schedule logic from the server across a communication network to a system controller module;
transmitting a new value from the system controller module to the device control module when indicated by the schedule logic;
receiving the new value at the device control module;
replacing a current set value in the device control module with the received new value;
sensing, at the device control module, a sensed parameter relevant to operation of the device; and
modifying operation of the device as a function of the sensed parameter and the new current set value.

15. The method of claim 14, wherein receiving programming instructions for a device includes executing an application on a smart phone that communicates over a communication network with the server, wherein the application provides a user interface for entering programming instructions for the device.

16. The method of claim 14, wherein receiving programming instructions for a device includes executing an application on a computer that communicates over a communication network with the server, wherein the application provides a user interface for entering programming instructions for the device.

17. The method of claim 14, wherein the device control module includes one or more control buttons, wherein activation of one of the one or more control buttons overrides the current set value stored in the device control module.

18. The method of claim 14, wherein the device control module includes a display and one or more control buttons, wherein activation of one of the one or more control buttons overrides the current set value stored in the device control module and displays the new current set value on the display.

19. The method of claim 14, wherein the device control module includes a display and wherein sensing, at the device control module, a sensed parameter includes displaying the sensed parameter value on the display.

20. The method of claim 14, wherein modifying operation of the device as a function of the sensed parameter and the new current set value includes setting relays.

21. The method of claim 14, wherein modifying operation of the device as a function of the sensed parameter and the new current set value includes communicating data across the first network to a relay module, wherein the relay module modifies operation of the device.

22. The method of claim 14, wherein the server includes an application that communicates over the Internet with a user interface device running a device interface application and wherein receiving programming instructions for the device includes receiving a communication from the user interface device with specific programming instructions.

23. The method of claim 22, wherein the device is a thermostat, wherein the device interface application presents a programmable thermostat interface, and wherein the server receives programming instructions for the device when changes are made on the programmable thermostat interface.

24. The method of claim 22, wherein the device is a sprinkler system, wherein the device interface application presents a programmable sprinkler system interface, and wherein the server receives programming instructions for the device when changes are made on the programmable sprinkler system interface.

25. In a system having a device to be controlled, a method for controlling the device, the method comprising:
receiving, at a server located at a location remote from the device, programming instructions for the changing operation of the device;
executing the programming instructions from within an application executing on the server in order to create schedule logic;
transmitting the schedule logic from the server across a communication network to a system controller module;
transmitting a new value from the system controller module to the device control module when indicated by the schedule logic;
receiving the new value at the device control module;
replacing a current set value in the device control module with the received new value; and
modifying operation of the device as a function of the new current set value.

26. The method of claim 25, wherein receiving programming instructions for a device includes executing an application on a smart phone that communicates over a communication network with the server, wherein the application provides a user interface for entering programming instructions for the device.

27. The method of claim 25, wherein receiving programming instructions for a device includes executing an application on a computer that communicates over a communication network with the server, wherein the application provides a user interface for entering programming instructions for the device.

28. The method of claim 25, wherein the device control module includes one or more control buttons, wherein activation of one of the one or more control buttons overrides the current set value stored in the device control module.

29. The method of claim 25, wherein the device control module includes a display and one or more control buttons, wherein activation of one of the one or more control buttons overrides the current set value stored in the device control module and displays the new current set value on the display.

30. The method of claim 25, wherein modifying operation of the device as a function of the new current set value includes setting relays.

31. The method of claim 25, wherein modifying operation of the device as a function of the new current set value includes communicating data across the first network to a relay module, wherein the relay module modifies operation of the device.

32. The method of claim 25, wherein the server includes an application that communicates over the Internet with a user interface device running a device interface application and wherein receiving programming instructions for the device includes receiving a communication from the user interface device with specific programming instructions.

33. The method of claim 32, wherein the device is a sprinkler system, wherein the device interface application presents a programmable sprinkler system interface, and wherein the server receives programming instructions for the device when changes are made on the programmable sprinkler system interface.

34. A distributed networked control system for controlling a device, comprising:
a device control module, wherein the device control module includes:
a network interface;
a control interface for controlling the device; and
a programmable controller connected to the network interface and the control interface, wherein the programmable controller includes a current set value; and
a system control module, wherein the system control module includes:
a first and a second network interface; and
a programmable controller connected to the network interface,
wherein the programmable controller includes program code;
wherein the system control module and the device control module can be connected via their network interfaces;
wherein the device control module modifies operation of the device as a function of the current set value; and
wherein the programmable controller for system control module includes program code which, when executed, causes the programmable controller for the system control module to transmit a new set value at preselected times to the device control module, wherein the new set value replaces the current set value.

35. The system of claim 34, wherein the device control module includes one or more input controls, wherein the input controls, when activated by a user, change the current set value.

36. The system of claim 34, wherein the device control module includes a display for displaying the current set value.

37. The system of claim 34, wherein the device control module further includes a sensor capable of sensing a parameter of interest to the device, wherein the device control module reads a parameter value from the sensor and modifies operation of the device as a function of the parameter measured by the sensor and the current set value.
